(19) United States
(12) Patent Application Publication
(10) Pub. No.: US 2026/0356654 A1
(43) Pub. Date: Nov. 12, 2026

(54) COCKTAIL MACHINE AND CALIBRATION METHOD

(71) Applicant: ASYTEC, Paris (FR)

(72) Inventor: Nicolas MAZEAUD, Paris (FR)

(73) Assignee: ASYTEC, Paris (FR)

(21) Appl. No.: 19/573,169

(22) Filed: Mar. 20, 2026

(30) Foreign Application Priority Data
Mar. 21, 2025 (FR) 2502909

(51) Int. Cl. B67D 1/12; B67D 1/08

(52) U.S. Cl. CPC B67D 1/1238; B67D 1/0888

(57) ABSTRACT

A cocktail machine with a liquid dispensing head, a pump configured to withdraw a volume of liquid from a container and convey it to the dispensing head, a sensor configured to measure a height of the volume dispensed into a predefined container, a controller connected to the sensor configured to determine the dispensed volume according to the height and a match between a predefined number of operating cycles of the pump and the corresponding volume of liquid dispensed into the predetermined receptacle, and a memory configured to save the match. Methods for calibrating the cocktail machine.

### TECHNICAL FIELD

The invention relates to the calibration of a cocktail machine, and in particular the calibration of a liquid dispensing circuit of such a machine.

### STATE OF THE ART

A cocktail machine generally comprises an area where containers of liquid (fruit juices, alcohol, syrups, etc.) are stored, typically bottles or bag-in-box (or BIB) containers, a dispensing head, at least one pump, pipes connecting the connectors to the dispensing head, and a controller configured to dispense liquids according to a predefined recipe.

The liquids dispensed having different viscosities, the same action of a pump to withdraw fluid may produce significantly different volumes.

However, the quality of the cocktail obtained depends particularly on the precision of the volume of each ingredient dispensed, such that it is necessary to take into account as precisely as possible the viscosity of the liquids used in making a cocktail.

Moreover, manually entering the type of liquid present in each container can be a tedious and time-consuming task for users.

### DISCLOSURE

An aim of the present disclosure is to provide a cocktail machine and a method for calibrating such a machine which is capable of obtaining a precise dosage of each liquid in an automated manner.

The aim is achieved thanks to a cocktail machine comprising:
a liquid dispensing head,
a pump configured to withdraw a volume of liquid from a container and convey it to the dispensing head,
a sensor configured to measure a height of the volume dispensed into a predetermined receptacle,
a controller connected to the sensor configured to determine the dispensed volume according to the height and a match between a predefined number of operating cycles of the pump and the corresponding volume of liquid dispensed into the predetermined receptacle, and
a memory configured to save the match.

Such a machine is advantageously and optionally supplemented by the following different features taken alone or in combination:
the pump is a peristaltic pump, the predefined number of operating cycles corresponding to a number of revolutions of a pump rotor;
the sensor is configured to measure a distance between the sensor and a surface located opposite in the receptacle, the receptacle having a known shape, and preferably the receptacle has a constant horizontal cross-section according to a height in the receptacle;
the sensor is an ultrasonic sensor or a laser sensor; and
the machine comprises the predetermined receptacle configured to receive the volume of liquid dispensed by the dispensing head;

The disclosure also relates to a method for calibrating a cocktail machine comprising the following steps:
controlling a pump to withdraw a volume of liquid from a container and convey it to a dispensing head,
dispensing by the dispensing head the volume of liquid into a predetermined receptacle,
measuring a height of the volume dispensed into the predetermined receptacle,
determining the volume dispensed on the basis of the height measured,
determining a match between a predefined number of operating cycles and the volume dispensed into the predetermined receptacle, and
saving the match.

Such a method is advantageously and optionally supplemented by
controlling the pump comprises rotating a rotor of the pump over a predefined number of revolutions;
measuring the height comprises measuring a distance between a sensor and a surface located opposite in the receptacle, the receptacle having a known shape, and preferably the receptacle has a constant horizontal cross-section according to a height in the receptacle;
measuring the height further comprises determining the distance between the sensor and a surface located opposite in the receptacle prior to the dispensing step in order to determine an initial distance, and determining the distance between the sensor and the liquid in the receptacle after the dispensing step in order to determine a final distance; and
the method comprises determining the shape of the receptacle comprising the following sub-steps:
   (S2) determining the initial distance;
   (S3) filling the receptacle with a predetermined volume of a liquid;
   (S4) measuring a final distance between the sensor and a surface of the liquid in the receptacle,
   (S5) determining a height of the liquid in the receptacle on the basis of the initial distance and the final distance;
   (S6) saving the match between the height and the predetermined volume;
   repeating sub-steps (S3), (S4), (S5) and (S6) at least once; and
   (S7) determining the shape of the receptacle on the basis of the saved matches.

### DESCRIPTION OF THE FIGURES

Further features, purposes and advantages will be more apparent from the following description, which is purely illustrative and not limiting, and which should be read with respect to the appended drawings in which:

FIG. 1 is a schematic representation of a cocktail machine, and

FIG. 2 is a schematic representation of a method for calibrating the cocktail machine.

### DETAILED DESCRIPTION

### Cocktail Machine

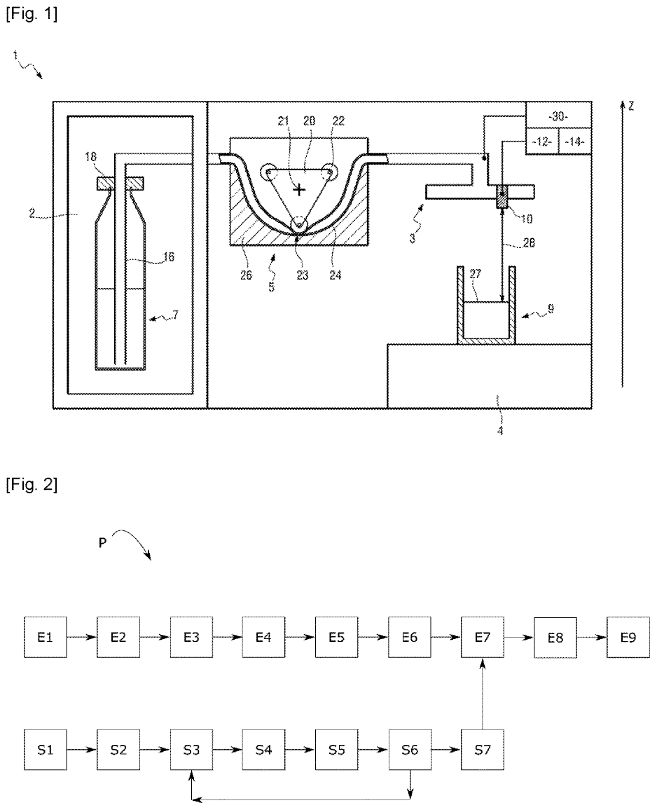

With reference to FIG. 1, a cocktail machine 1 comprises an area 2 for storing one or more containers 7 of liquid (fruit juice, alcohol, syrups, etc.). These containers are typically bottles or bag-in-box (or BIB) containers. This area 2 may be a closed and optionally refrigerated housing or an open area for example located on the top of the cocktail machine 1.

The cocktail machine 1 comprises a circuit 16 for transporting the liquid contained in the container 7. The circuit 16 may particularly comprise a stopper 18 configured to close the container 7 and allow a flow of liquid to the rest of the circuit 16. The circuit 16 may comprise a pipe which dips into the container 7 particularly when the container 7 is stored in a position where the stopper 18 is located at the top of the container 7. Alternatively, the container 7 may be stored “upside down”, i.e. the stopper 18 of the container 7 is located at the bottom of the container 7.

The cocktail machine 1 may comprise as many transport circuits 16 as there are liquid containers 7.

The transport circuit 16 comprises a pump 5. The pump 5 is configured to withdraw a volume of liquid from the container 7 and move it in the transport circuit 16. The pump 5 is configured to operate according to predefined cycles. For example, the pump 5 comprises a movable portion and a fixed portion, the movable portion being configured to carry out a movement relative to the fixed portion along a closed trajectory. This means that at the start and end of the closed trajectory, the movable part has the same position relative to the stator. An operating cycle corresponds to one or more loops of the closed trajectory. For example, the pump 5 comprises a rotor and a stator and the closed trajectory corresponds to a complete revolution of the rotor relative to the stator. An operating cycle may then correspond to one or more complete revolutions of the rotor.

The pump 5 may particularly be a peristaltic pump. In this case, the liquid flows in a flexible pipe 24 through the pump 5, the flexible pipe 24 being kept fixed against a fixed wall 26. The peristaltic pump comprises a rotor 20 which rotates about an axis 21. The rotor actuates in its rotation one or more rollers 22 configured to compress the flexible pipe 24 against the fixed wall 26. The compression 23 produced by the rollers follows the same rotational movement as the roller 22. The compression 23 forces a displacement of the liquid contained in the flexible pipe such that the roller 22 actuates in its rotational movement a volume of liquid in the flexible pipe.

The transport circuit 16 comprises a dispensing head 3 configured to dispense liquid extracted from the container 7 and moved in the circuit 16 by the pump 5.

The dispensing head 3 is fluidically connected to the pump 5.

The cocktail machine comprises a base 4 configured to accommodate a receptacle 9 such as a cocktail glass. The base 4 is disposed facing the dispensing head 3. This means that the base 4 is facing the head 3 and the area between the base 4 and the head 3 is a clearance. Such a clearance particularly means that the material of the cocktail machine does not extend between the head 3 and the base 4. The base 4 is preferably placed below the head 3 in order to collect a liquid dispensed by the head 3. This means that a vertical axis Z passing through the head 3 also passes through the base 4. In practice, the vertical axis corresponds to the direction of gravity. The base 4 defines an upper surface on which it is possible to place the receptacle 9. The receptacle 9 is then located between the head 3 and the base 4, and facing the head 3.

The receptacle 9 defines an internal volume configured to receive liquid

In particular, a predetermined receptacle 9 may be placed on the base 4, i.e. a receptacle of which the geometric characteristics which make it possible to determine the value of the volume of liquid contained in the receptacle according to the height of the liquid level in the receptacle are known.

These geometric characteristics are particularly known when the shape of the receptacle is known. The shape of the receptacle particularly comprises variations in the shape of the internal volume of the receptacle according to the height in the receptacle 9. Here, height in the receptacle means a coordinate along the vertical direction Z which equals zero at the bottom of the receptacle and which takes positive values when rising vertically above the bottom.

The internal volume is indeed defined by the height measured along the vertical direction Z, as well as the shape, and particularly the diameter, of the internal volume according to the height in the receptacle 9. Here, diameter means the largest dimension in a horizontal plane of the internal volume of the glass.

The internal volume of the receptacle may have different shapes in the horizontal cross-section. For example, the cross-section of the internal volume may be circular such that the diameter of the volume corresponds to the diameter of the corresponding circle. For example, the cross-section of the internal volume may be rectangular such that the diameter of the volume corresponds to the greatest length of the corresponding rectangle.

The shape of the horizontal cross-section may be constant over the entire height or it may have a variation according to the height in the receptacle.

Similarly, the diameter may be constant over the entire height or it may have a variation according to the height in the receptacle.

In a first example, the receptacle 9 defines an internal volume of a circular horizontal cross-section of constant diameter over the entire height of the glass. In this case, knowing the diameter of the glass and measuring the height of the level of liquid in the receptacle makes it possible to determine the volume of liquid contained in the glass.

In a second example, the receptacle 9 defines an internal volume of a circular horizontal cross-section of which the diameter varies according to the height of the glass. In this case, knowing the variation of the diameter according to the height and measuring a height of the level of liquid in the receptacle make it possible to determine the volume of liquid contained in the glass.

The cocktail machine comprises a sensor 10 configured to measure a height of the volume dispensed into a predetermined receptacle 9. The cocktail machine also comprises a controller 30 configured to determine the value of the volume of liquid contained in the receptacle according to the height of the level of liquid in the receptacle. The controller 30 is connected to the memory 14 which can contain the geometric characteristics of the receptacle 9 and code instructions for determining the height of the liquid in the receptacle 9. The controller 30 may be of the processor, microprocessor, microcontroller, etc. type configured to execute these code instructions. The controller 30 may also determine a match between a predefined number of operating cycles of the pump 5 and a corresponding volume of liquid dispensed into the predetermined receptacle 9.

The sensor 10 comprises for example a camera configured to produce an image of the receptacle 9 filled with a dispensed volume. The sensor 10 may comprise in this case a computer 12 which is configured to process the image and deduce therefrom a height of liquid in the receptacle.

Alternatively, the sensor 10 is configured to determine a distance 28 between the sensor 10 and a surface 27 located opposite the sensor 10 in the receptacle 9. The sensor 10 may comprise in this case a computer 12 which is configured to compute a difference between two height measurements determined by the sensor 10. The sensor 10 may for example comprise an ultrasonic detector or a laser detector. Such a detector is configured to produce and send to the receptacle 9 an incident sound or light wave. The incident wave is propagated in the clearance up to the surface 27. The wave is at least partially reflected by the surface 27. If the receptacle 9 is empty, the surface 27 corresponds to the inner surface of the bottom of the receptacle. If the receptacle 9 contains a volume of liquid, the surface 27 corresponds to the free surface of the liquid contained in the receptacle. The reflected wave is propagated in the clearance of the surface 27 up to the sensor 10. The determination by the processor of the delay between transmitting the incident wave and receiving the reflected wave makes it possible to determine the distance 28. The detector is advantageously located in vertical alignment with the base 4, such that the receptacle can be positioned below and in vertical alignment with the detector 10. The receptacle 9, the detector 10 and the dispensing head 3 are configured such that it is possible to dispose the receptacle 9 on the base 4 in a position where, on the one hand, the head 3 can dispense liquid inside the receptacle and, on the other hand, the detector 10 is located facing the inside of the receptacle 9, and in particular in vertical alignment with the inside of the receptacle 9.

The cocktail machine 1 further comprises a memory 14 configured to save cocktail recipes and geometric data of the receptacle 9, in particular geometric characteristics of the receptacle 9 which make it possible to determine the value of the volume of liquid contained in the receptacle 9 according to the height of the level of liquid in the receptacle 9.

The controller 30 is connected to the memory 14, the controller 30 being configured to control the pump 5 and the sensor 10.

The cocktail machine as described so far may further comprise the predetermined receptacle 9 and configured to receive the volume of liquid dispensed by the dispensing head.

### Calibration Method

A cocktail machine as just described above makes it possible to implement a calibration method P.

An exemplary method P is illustrated by way of non-limiting example in FIG. 2.

During a step E1, the inside of a receptacle 7 is fluidically connected to the transport circuit 16 of the cocktail machine 1.

During a step E2, a predetermined receptacle 9 is placed on the base 4 opposite the dispensing head and the sensor 10. The empty receptacle is placed on the base 4.

During an optional step E3, the sensor 10 determines an initial distance between the sensor 10 and the surface of the bottom of the receptacle 9. This step E3 is particularly carried out if the sensor comprises an ultrasonic detector or a laser detector.

During a step E4, the controller 30 controls the pump 5 to withdraw a volume of liquid from the container 7 and convey it to the dispensing head 3. For this purpose, the controller 30 controls the pump to perform a given number of operating cycles of the pump 5. For example, when the pump 5 is a peristaltic pump, the controller 30 controls the pump such that the rotor carries out a given number of revolutions, for example 5 or 10 revolutions.

During a step E5, the dispensing head 3 dispenses into the predetermined receptacle 9 the liquid volume of the container withdrawn by the pump 5.

During a step E6, the sensor 10 determines a height of the volume dispensed into the receptacle 9.

For example, if the sensor comprises an ultrasonic detector or a laser detector, the sensor 10 measures a final distance between the sensor 10 and the free surface of the volume of liquid contained in the receptacle 9, then the sensor 10, for example via the computer 12, determines the height as the difference between the final distance and the initial distance obtained in step E3.

For example, if the sensor 10 comprises a camera, the camera takes an image during the sixth step E6 and the computer 12 of the sensor 10 processes the image to deduce therefrom the height of the liquid in the receptacle.

During a step E7, the controller 30 determines the dispensed volume on the basis of the height determined in step E6. In other words, the controller 30 determines a value of the volume that was dispensed into the receptacle 9 during step E5. For this purpose, the controller 30 uses particularly the geometric characteristics which make it possible to determine the value of the volume of liquid contained in the receptacle according to the height of the level of liquid in the receptacle. These characteristics may be pre-recorded in the memory 14.

In particular, if the receptacle 9 defines an internal volume of a circular horizontal cross-section of constant diameter over the entire height of the glass, the geometric characteristics comprise the diameter of the receptacle. The internal volume may be determined as the product of the height measured by the surface of a circle of which the diameter is equal to the diameter of the receptacle.

When the receptacle 9 defines an internal volume of a circular horizontal cross-section of which the diameter varies according to the height of the glass, the geometric characteristics comprise the variation of the diameter according to the height. This consists of the diameter of a horizontal cross-section of the internal volume of the receptacle. Each horizontal cross-section corresponds to a specific height. In other words, the geometric characteristics comprise a function representing the diameter, the function varying according to a variable representing the height of the liquid in the receptacle. The internal volume may then be determined as an integral of the function between a zero height corresponding to the bottom of the glass and a height equal to the height determined in step E7.

During a step E8, the controller 30 determines a match between the predefined number of operating cycles and the volume dispensed into the predetermined receptacle 9. The number of cycles corresponds to the given number of operating cycles of the pump 5 mentioned in step E4. This match makes it possible to ascertain the number of cycles that the pump must perform to dispense a desired volume of the liquid contained in the container 7. In other words, the calibration method makes it possible to dispense a desired volume of liquid regardless of the viscosity of the liquid.

During a step E9, the memory 14 saves the match. The controller 30 subsequently uses this saved match to match a desired volume of the liquid in a number of cycles of the pump 5.

When preparing a cocktail, the controller 30 converts, in order to produce a pre-recorded recipe, a desired volume of liquid in ml into a number of pump cycles. This may be carried out for each ingredient.

The method P may advantageously comprise determining the shape of the receptacle if it is not known. This determination comprises the following sub-steps. For this determination, the sensor comprises an ultrasonic detector or a laser detector.

During a sub-step S1, a predetermined receptacle 9 is placed on the base 4 opposite the dispensing head and the sensor 10. The empty receptacle is placed on the base 4.

During a sub-step S2, the sensor 10 measures an initial distance between the sensor 10 and the surface of the bottom of the receptacle 9.

During a sub-step S3, the receptacle is filled with a predetermined volume of a liquid. This may consist of water or any other liquid. The volume filled in the receptacle is known.

During a sub-step S4, the sensor 10 measures a final distance between the sensor and a surface of the liquid in the receptacle.

During a sub-step S5, the sensor 10 determines a height of the volume dispensed into the receptacle 9.

During a sub-step S6, the memory 14 saves the match between the height and the predetermined volume.

Sub-steps S3, S4, S5 and S6 are repeated at least once, using a known volume of different liquid.

Advantageously, these sub-steps S3, S4, S5 and S6 are repeated a plurality of times, the known volume of liquid being different each time.

During a sub-step S7, the computer 12 determines the shape of the receptacle on the basis of the saved matches.

The computer 12 determines the shape of the receptacle in that it determines the geometric characteristics which make it possible to determine the value of the volume of liquid contained in the receptacle according to the height of the level of liquid in the receptacle.

Each determined match corresponds to the pair of a height in the receptacle and a volume of liquid reaching that height in the receptacle. The greater the number of matches determined, the more precisely the shape of the receptacle is known.

The determined shape of the receptacle may then be used during the seventh step E7 described above.

1. A cocktail machine (1) comprising:
a liquid dispensing head (3),
a pump (5) configured to withdraw a volume of liquid from a container (7) and convey it to the dispensing head (3),
a sensor (10) configured to measure a height of the volume dispensed into a predefined container (9),
a controller (30) connected to the sensor configured to determine the dispensed volume according to the height and a match between a predefined number of operating cycles of the pump (5) and the corresponding volume of liquid dispensed into the predetermined receptacle (9), and
a memory (14) configured to save the match.

2. The cocktail machine according to claim 1, wherein the pump is a peristaltic pump, the predefined number of operating cycles corresponding to a number of revolutions of a pump rotor (20).

3. The cocktail machine according to claim 1, wherein the sensor is configured to measure a distance (28) between the sensor (10) and a surface (27) located opposite in the receptacle, the receptacle having a known shape, and preferably the receptacle has a constant horizontal cross-section according to a height in the receptacle.

4. The cocktail machine according to claim 3, wherein the sensor is an ultrasonic sensor or a laser sensor.

5. The cocktail machine according to claim 1, further comprising the predetermined receptacle (9) configured to receive the volume of liquid dispensed by the dispensing head.

6. A method (P) for calibrating a cocktail machine (1) comprising the following steps:
(E4) controlling a pump (5) to withdraw a volume of liquid from a container (7) and convey it to a dispensing head (3),
(E5) dispensing by the dispensing head (3) the volume of liquid into a predetermined receptacle (9),
(E6) measuring a height of the volume dispensed into the predetermined receptacle (9),
(E7) determining the volume dispensed from the measured height,
(E8) determining a match between a predefined number of operating cycles and the volume dispensed into the predetermined receptacle (9), and
(E9) saving the match.

7. The method according to claim 6, wherein controlling the pump comprises rotating a rotor (20) of the pump over a predefined number of revolutions.

8. The method according to claim 6, wherein measuring the height comprises measuring a distance (28) between a sensor (10) and a surface (27) located opposite in the receptacle, the receptacle having a known shape, and preferably the receptacle has a constant horizontal cross-section according to a height in the receptacle.

9. The method according to claim 8, wherein measuring the height further comprises determining (E3) the distance (28) between the sensor and a surface (27) located opposite in the receptacle before the dispensing step in order to determine an initial distance, and determining the distance between the sensor and the liquid in the receptacle after the dispensing step in order to determine a final distance.

10. The method according to claim 9 comprising determining the shape of the receptacle comprising the following sub-steps:
(S2) determining the initial distance;
(S3) filling the receptacle with a predetermined volume of a liquid;
(S4) measuring a final distance between the sensor and a surface of the liquid in the receptacle,
(S5) determining a height of the liquid in the receptacle on the basis of the initial distance and the final distance;
(S6) saving the match between the height and the predetermined volume;
repeating sub-steps (S3), (S4), (S5) and (S6) at least once; and
(S7) determining the shape of the receptacle on the basis of the saved matches.
